(19) United States
(12) Patent Application Publication
(10) Pub. No.: US 2006/0256232 A1
(43) Pub. Date: Nov. 16, 2006

(54) Moving picture communication system

(75) Inventor: Yukinori Noguchi, Ashigara-Kami-Gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD

(21) Appl. No.: 11/432,343

(22) Filed: May 12, 2006

(30) Foreign Application Priority Data
May 12, 2005 (JP) 2005-139991

(51) Int. Cl. H04N 11/02

(52) U.S. Cl. 348/386.1

(57) ABSTRACT

The moving picture communication system comprises communication terminals configured to mutually send and receive a color moving picture including luminance information and color information through a network to which the communication terminals are connected. Each of the communication terminals comprises: a transfer bandwidth information acquisition device which acquires transfer bandwidth information representing a bandwidth of a communication path through which the color moving picture is sent and received; a color information compression device which compresses the color information of the color moving picture in accordance with the transfer bandwidth information acquired by the transfer bandwidth information acquisition device; an encoding device which encodes the color moving picture outputted from the color information compression device; a transmission device which transmits the color moving picture encoded by the encoding device; a reception device which receives the encoded color moving picture transmitted from another of the communication terminals; a decoding device which decodes the encoded color moving picture received by the reception device; and a color moving picture output device which outputs the color moving picture decoded by the decoding device.

### BACKGROUND OF THE INVENTION

1. Field of the Invention

The present invention relates to a moving picture communication system, and more particularly, to a moving picture communication system for transmitting and receiving a color moving picture between devices connected to a network.

2. Description of the Related Art

In the related art, Japanese Patent Application Publication No. 2002-247383 proposes a data transmission and reception method which enables color moving pictures to be transmitted at high speed between devices having low communication capability.

On the transmission side of this data transmission and reception method, a color moving picture inputted from a video camera is converted into still pictures at certain time points, and the still pictures are compressed. Moreover, the color moving picture is converted into a black and white moving picture having a reduced number of pixels. The compressed color still pictures and the black and white moving picture are then transmitted.

On the receiving side, on the other hand, the received color still pictures are analyzed into color pixels to obtain color information, and the color moving picture is restored on the basis of this color information and the received black and white moving picture.

Furthermore, it is known that, when the moving picture stream is encoded, the frame rate can be varied and the image size can be changed, in accordance with the transmission bandwidth.

However, in such a data transmission and reception method which colorizes a black and white moving picture on the basis of a black and white moving picture and color still pictures at some time points, if there is large movement of the subject of the pictures, then it is difficult to obtain a satisfactory color moving picture unless the frequency of sending the color still pictures is set to be very high, and consequently, it can be difficult to reduce the data volume. Furthermore, since the number of pixels is reduced in the black and white moving picture, then it is difficult to achieve a moving picture of high resolution even if a color moving picture can be obtained.

Moreover, if the frame rate of the moving picture stream is reduced in accordance with the bandwidth of the communication path, then when the subject moves, it may be difficult to see the details of the movement of the subject on the restored moving picture.

### SUMMARY OF THE INVENTION

The present invention has been contrived in view of the foregoing circumstances, an object thereof being to provide a moving picture communication system whereby a moving picture having smooth movement and a high resolution can be transmitted and received, even if there is variation in the transmission bandwidth of the communication path.

In order to attain the aforementioned object, the present invention is directed to a moving picture communication system, comprising communication terminals configured to mutually send and receive a color moving picture including luminance information and color information through a network to which the communication terminals are connected, wherein each of the communication terminals comprises: a transfer bandwidth information acquisition device which acquires transfer bandwidth information representing a bandwidth of a communication path through which the color moving picture is sent and received; a color information compression device which compresses the color information of the color moving picture in accordance with the transfer bandwidth information acquired by the transfer bandwidth information acquisition device; an encoding device which encodes the color moving picture outputted from the color information compression device; a transmission device which transmits the color moving picture encoded by the encoding device; a reception device which receives the encoded color moving picture transmitted from another of the communication terminals; a decoding device which decodes the encoded color moving picture received by the reception device; and a color moving picture output device which outputs the color moving picture decoded by the decoding device.

According to this aspect of the present invention, the transfer bandwidth of the communication path is monitored by the transfer bandwidth information acquisition device, and if the transfer bandwidth narrows and it becomes difficult to adequately send and receive a color moving picture including the color information and the luminance information, then the color information of the color moving picture is compressed (reduced) in accordance with the bandwidth, thereby gradually changing the images into black and white images. Accordingly, it is possible to send and receive a moving picture of high resolution, while preventing feelings of incongruity.

Preferably, the color information is saturation information; and the color information compression device reduces an amount of the saturation information as the bandwidth narrows, in accordance with the acquired transfer bandwidth information.

Regarding the method for reducing the volume of saturation information, a bit shift operation which removes bit information, starting from the low bit, in order to reduce the bit depth, may be used.

Preferably, the transfer bandwidth information acquisition device acquires the transfer bandwidth information in accordance with delay information of the color moving picture received from the other communication terminal performing two-way communication of the color moving picture.

Preferably, if the color information is compressed by the color information compression device, the encoding device adds compression information relating to this compression to the encoded color moving picture; and if the reception device receives the compression information in addition to the color moving picture, the decoding device decodes the received color moving picture in accordance with this compression information.

According to this aspect of the present invention, on the transferring side, compression information which indicates what type of compression has been carried out with respect to the color information is added to the color moving picture. On the receiving side, the color moving picture is restored on the basis of the compression information which is received along with the color moving picture.

According to the present invention, when a color moving picture is sent and received through a network, the transfer bandwidth of the communication path is monitored, and if the transfer bandwidth changes and it becomes difficult to send or receive a color moving picture adequately, then the color information, of the luminance information and color information constituting the color moving picture, is reduced in accordance with the bandwidth, thereby gradually changing the image into a black and white image. Therefore, it is possible to send and receive a smooth moving picture at high resolution, in comparison with a case where the number of pixels or the frame rate is reduced, and furthermore, it is also possible to send and receive a color moving picture which does not create a feeling in incongruity, by making the image become a black and white image in a gradual fashion.

### BRIEF DESCRIPTION OF THE DRAWINGS

The nature of this invention, as well as other objects and benefits thereof, will be explained in the following with reference to the accompanying drawings, wherein:

FIG. 1 is a block diagram showing a moving picture communication system according to an embodiment of the present invention;

FIG. 2 is a block diagram showing an example of the internal composition of a communication terminal which is a component of the moving picture communication system;

FIG. 3 is an oblique front diagram of the communication terminal;

FIG. 4 is a schematic diagram of an encoding unit which encodes a moving picture stream;

FIGS. 5A to 5C are diagrams used to describe a macro-block forming a minimum encoding unit;

FIG. 6 is a schematic diagram of a decoding unit which decodes the encoded data; and

FIG. 7 is a diagram used to describe a method of reducing the number of bits in accordance with the transfer bandwidth.

### DETAILED DESCRIPTION OF THE PREFERRED EMBODIMENTS

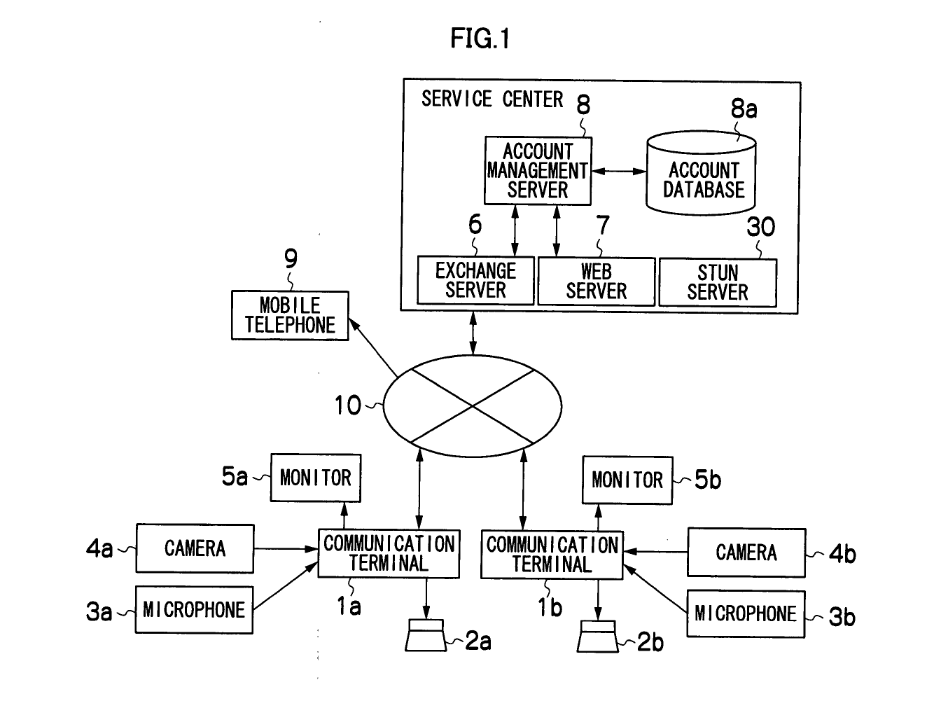

FIG. 1 is a block diagram showing a moving picture communication system according to an embodiment of the present invention.

In this system, a communication terminal 1a and a communication terminal 1b having the same composition (hereinafter also referred to jointly as “communication terminal 1”), are connected to each other via a network 10, such as the Internet, so that video data (representing color moving pictures) and audio data are transmitted between these terminals.

The connection path between the communication terminal 1a and the communication terminal 1b is specified by an exchange server 6 constituted by a SIP (Session Initiation Protocol) server, using a network address (global IP (Internet Protocol) address, and the like), a port and an identifier (MAC (Media Access Control) address, or the like). Information relating the user of the communication terminal 1, such as the name and email address, and information relating to the connection of the communication terminal 1 (account information) are stored in an account database (DB) 8a, and are managed by an account management server 8. The account information can be updated, modified or deleted through a communication terminal 1 connected to the account management server 8 via a Web server 7. The Web server 7 also serves as a mail server for sending mails (e-mails) and a file server for downloading files.

The communication terminal 1a is connected to a microphone 3a, a camera 4a, a speaker 2a and a monitor 5a. Video data captured through the camera 4a, and audio data gathered through the microphone 3a, are transmitted to the communication terminal 1b via the network 10. The communication terminal 1b is also connected to a microphone 3b, a camera 4b, a speaker 2b and a monitor 5b, and is able to transmit the video data and the audio data to the communication terminal 1a in a similar fashion.

The video data and the audio data received by the communication terminal 1b are reproduced through the monitor 5b and the speaker 2b, and the video data and the audio data received by the communication terminal 1a are reproduced through the monitor 5a and the speaker 2a.

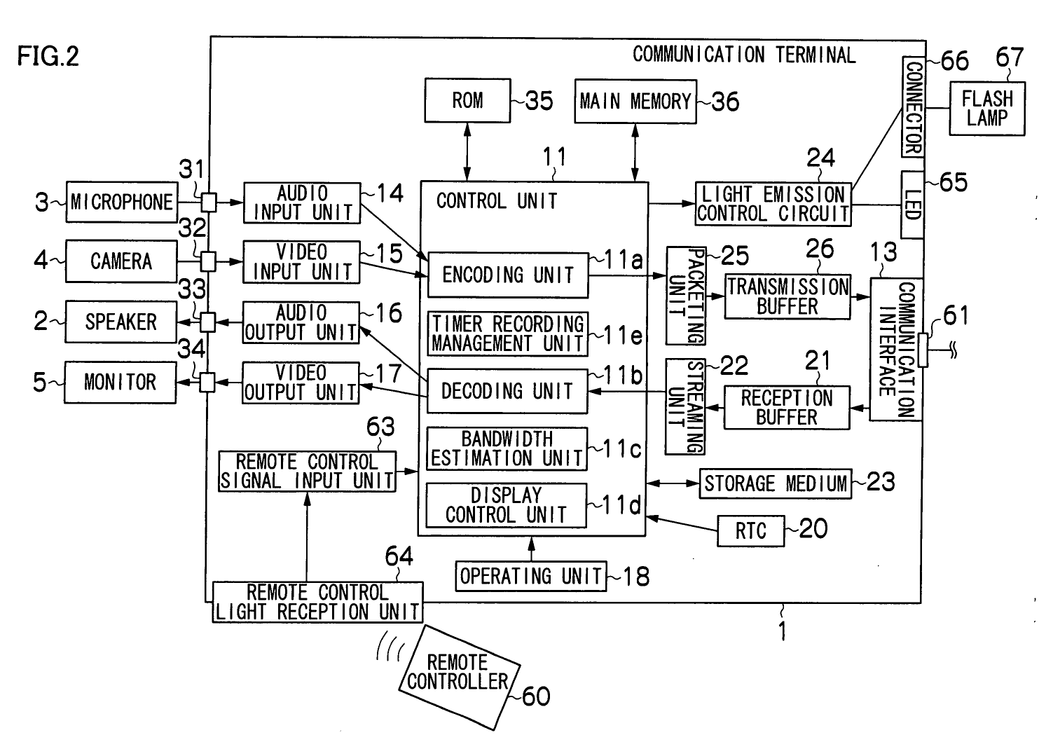

FIG. 2 is a block diagram showing an example of the internal composition of the communication terminal 1.

An audio input connector 31, a video input connector 32, an audio output connector 33, and a video output connector 34 are provided on the outer surface of the main body of the communication terminal 1, and are connected respectively to the microphone 3, the camera 4, the speaker 2 and the monitor 5. The microphone 3 and the speaker 2 may be integrated into a headset.

An audio signal inputted to an audio input unit 14 from the microphone 3 connected to the audio input connector 31, and a video signal inputted to a video input unit 15 from the camera 4 connected to the video input connector 32, are digitized, compressed, encoded, and converted into stream data (content data in a format compatible with real-time distribution), by an encoding unit 11a constituted by an encoder compatible with high image quality, such as an MPEG-2 encoder or an MPEG-4 encoder (MPEG stands for Moving Picture Experts Group).

The stream data is converted into packets by a packeting unit 25, and then stored temporarily in a transmission buffer 26. The transmission buffer 26 sends the packets to the network 10 at regular intervals, via a communication interface 13. The transmission buffer 26 has a capacity for storing and sending one frame of data in one packet, when a moving image having 30 frames per second is read in, for example.

A bandwidth estimation unit 11c estimates the bandwidth of the transfer path on the network 10 through which the packets are to be transferred, on the basis of the jitter (fluctuation) of the network 10, and the like, and then the bandwidth estimation unit 11c adjusts the data volume encoded by the encoding unit 11a in accordance with the transfer bandwidth thus estimated. The details of the processing of the encoding unit 11a on the basis of the estimated transfer bandwidth are described later.

On the other hand, the packets of the stream data received from the other communication terminal 1 via the communication interface 13 are stored temporarily in a reception buffer 21, and are then outputted to a streaming unit 22 at regular intervals. The streaming unit 22 reassembles content data from the received packets. The content data is then decoded by a decoding unit 11b constituted by an MPEG-2 decoder or an MPEG-4 decoder, or the like. The video data included in the content data is converted into an NTSC (National Television Standards Committee) signal by a video output unit 17, and the NTSC signal is outputted to the monitor 5. The audio data included in the content data is converted into an analog audio signal by an audio output unit 16, and the analog audio signal is outputted to the speaker 2.

The communication interface 13 is provided with a network connector 61, which is connected to a broadband router, ADSL (Asymmetric Digital Subscriber Line) modem, or the like, by various cables, so as to be connected to the network 10.

It is recognized by persons skilled in the art that if the communication interface 13 is connected to a router having firewall or NAT functions (NAT stands for Network Address Translation, which can achieve interconversion between a global IP address and a private IP address), then it is difficult to make the direct connection between the communication terminals 1 according to SIP (known as “NAT problem”). It is possible to provide a relay server compatible with a NAT traversal function, such as a STUN (Simple Traversal of UDP (User Datagram Protocol) through NATs) server 30 or a UPNP (Universal Plug and Play) server, with the purpose of relaying the connection between the communication terminals 1. In order to prevent the occurrence of delay in the transmission and reception of the video and audio data, it is preferable that various types of NAT traversal functions which do not operate via a relay server are incorporated into the communication terminals 1 (see, for example, Japanese Patent Application Publication No. 2003-352950).

The control unit 11 controls the units in the communication terminal 1, on the basis of operational inputs from an operating unit 18, which is constituted by various types of buttons, keys, and the like. The control unit 11 includes a calculation device, such as a CPU (central processing unit), which achieves the functions of the encoding unit 11a, the decoding unit 11b, the bandwidth estimation unit 11c, a display control unit 11d, and a timer recording management unit 11e, by means of programs stored on a storage medium 23.

The display control unit 11d controls the output of video signals to the monitor 5. Hereinafter, for the purpose of simplicity, it is supposed that all of the video signals outputted to the monitor 5 are controlled by the display control unit 11d. However, it is also possible to change the video signal outputted from the communication terminal 1 to the monitor 5, to a standard television broadcast signal.

The address for uniquely identifying each communication terminal 1 (which is not necessarily synonymous with the global IP address), a password required by the account management server 8 in order to authenticate the communication terminal 1, and a startup program for the communication terminal 1, are all stored in a ROM 35, which is capable of holding data even if the power supply is switched off. The ROM 35 is constituted by a flash ROM, or the like, and the programs stored thereon can be updated to the latest version by means of an updating program supplied by the account management server 8.

The data required for the various processes carried out in the control unit 11 is stored in a main memory 36 constituted by a RAM, which temporarily stores data.

The storage medium 23 is a removable medium, such as a compact flash card, and it is used principally for reading and writing the video data and audio data. The storage medium 23 is also capable of storing the application program of the control unit 11, and the application program can be updated to the latest version by means of an updating program supplied by the account management server 8.

The communication terminal 1 is provided with a remote control signal input unit 63, which is connected to a remote control light reception unit 64. The remote control light reception unit 64 converts an infrared light signal received from a remote controller 60 into an analog electric signal, and the remote control signal input unit 63 converts the analog electric signal inputted from the remote control light reception unit 64 into a digital signal, which is sent to the control unit 11. The control unit 11 controls the various operations in accordance with the digitized remote control signal inputted from the remote control signal input unit 63.

The control unit 11 controls a light control circuit 24 for blinking or lighting on and off of light-emitting diodes (LEDs) 65 arranged on the outer face of the communication terminal 1. It is possible that the light control circuit 24 is connected to a flash lamp 67 through a connector 66, and controls blinking or flashing on and off of the flash lamp 67. The control unit 11 uses a real time clock (RTC) unit 20 as an internal clock.

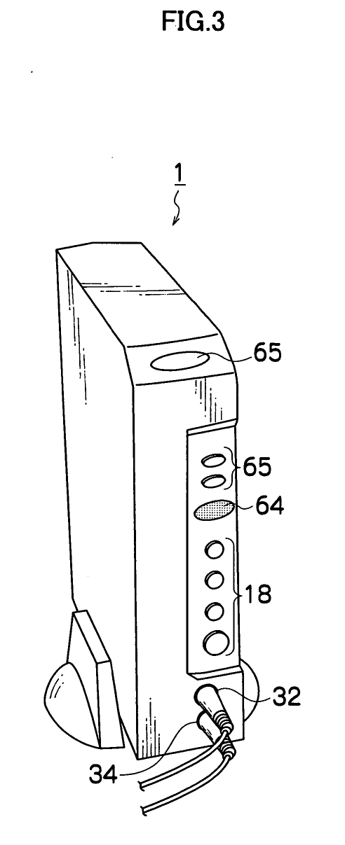

FIG. 3 is an oblique front side diagram showing an external appearance of the communication terminal 1. The communication terminal 1 is a set top box (STB) comprising an erect-type frame body. In the front area of the frame body, the remote control light reception unit 64, the operating unit 18 including a power button and the like, the LEDs 65 including a “data reception” light, a “timer set” light and the like, the video input connector 32, the video output connector 34, and the like, are arranged. Although not shown in FIG. 3, the network connector 61, the audio input connector 31, the audio output connector 33, and the like, are arranged on the rear area of the frame body.

Next, the encoding unit 11a shown in FIG. 2 is described below.

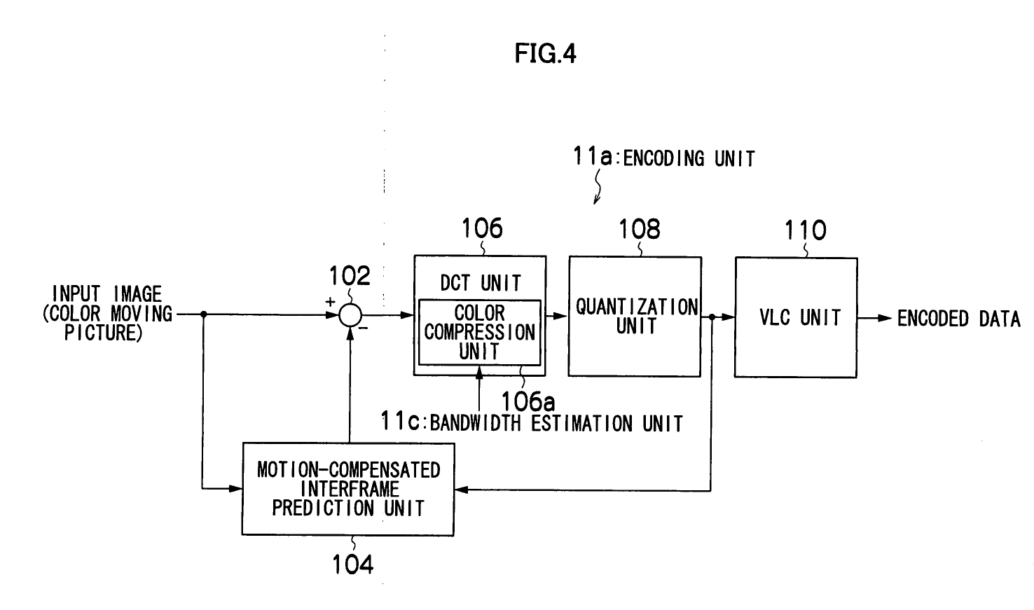

FIG. 4 is a schematic diagram of the encoding unit 11a, and it shows the portions about encoding color moving pictures, in particular.

This encoding unit 11a comprises an adder 102, a motion-compensated interframe prediction unit 104, a DCT (discrete cosine transformation) unit 106, a quantization unit 108, and a VLC (variable length coding) unit 110.

The encoding unit 11a creates an I-picture (intra-coded), a P-picture (predictive-coded) and a B-picture (bidirectionally predictive-coded), from the inputted picture. The I-picture is encoded using solely the information in that frame, the P-picture is encoded as a differential image by using information from the frame being coded and from a previous frame, and the B-picture is encoded as a differential image by using information from the frame being coded and from a previous or future frame.

The image (color moving picture) inputted through the video input unit 15 is supplied to the adder 102 and the motion-compensated interframe prediction unit 104.

The motion-compensated interframe prediction unit 104 performs an inverse quantization, an inverse DCT, and the like, of the previously quantized image inputted from the quantization unit 108, and thereby creates a previous image. Then, the motion-compensated interframe prediction unit 104 determines motion vectors on the basis of the current input image and the previous image, and compensates (corrects) the previous image for movement according to the motion vectors, and then outputs the compensated image to the adder 102.

When the P-picture or the B-picture is encoded, the adder 102 subtracts the previous image that has been compensated for movement by the motion-compensated interframe prediction unit 104, from the currently inputted image, thereby finds a differential image, and outputs this differential image to the DCT unit 106. When the I-picture is encoded, the adder 102 outputs the input image without alteration, to the DCT unit 106.

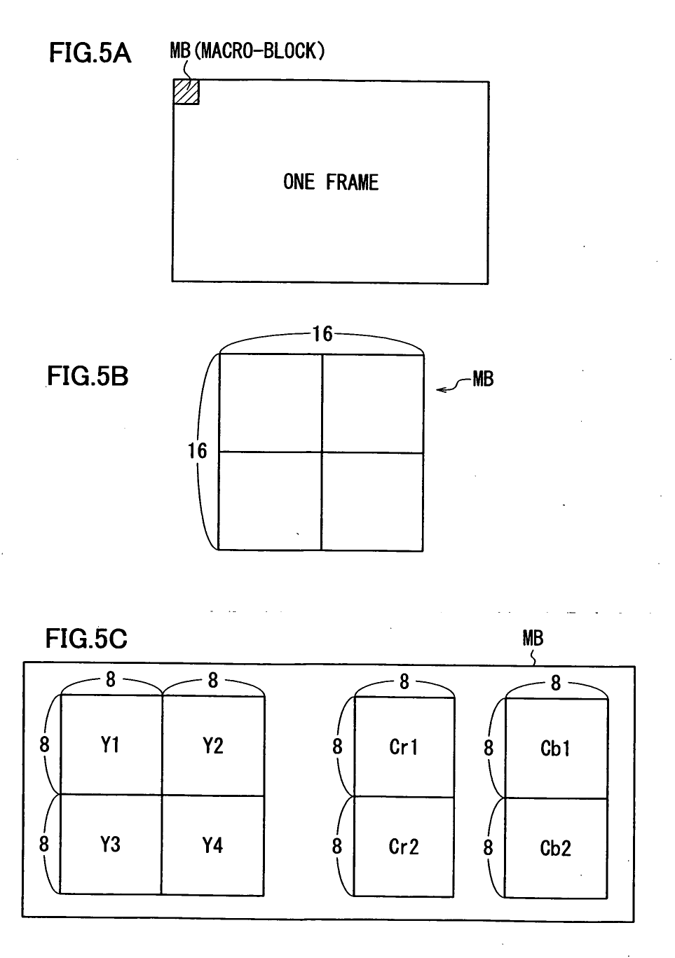

As shown in FIGS. 5A and 5B, the DCT unit 106 uses macro blocks MB of 16×16 pixels extracted from one frame, as minimum encoding units, and the size of the DCT is 8×8. As shown in FIG. 5C, the DCT unit 106 allocates the luminance signal Y to four blocks Y1, Y2, Y3 and Y4, allocates each of the color differential signals Cr and Cb to two blocks, Cr1 and Cr2, and Cb1 and Cb2, and carries out an 8×8 two-dimensional DCT for each block. The DCT operation has the function of concentrating the image signal into a smaller number of low-frequency coefficients, and hence makes it possible to reduce the amount of information about a spatial direction of the image. Furthermore, the DCT unit 106 also includes a color compression unit 106a. This color compression unit 106a compresses the data volume of the blocks Cr1 and Cr2, and Cb1 and Cb2, on the basis of the bandwidth information inputted from the bandwidth estimation unit 11c. The details of the color compression unit 106a are described later.

In the image format shown in FIG. 5C, the data volume of each of the color differential signals Cr and Cb constituting pixels is reduced by one half, in the horizontal direction, and the ratio of Y, Cr and Cb is 4:2:2, where Y=4, Cr=2, and Cb=2. Since the human eye is less perceptive for color than for luminance, then even if the color information is reduced, no substantial decline in image quality is appreciated.

The quantization unit 108 quantizes the DCT coefficients created by the DCT unit 106, by means of a quantization table, and carries out processing for reducing the code volume by representing all of the DCT coefficients by a set of low-value numbers. The VLC unit 110 encodes the quantized data by means of a Huffman table (it carries out the allocation of codes, in accordance with the probabilities of appearance of codes).

The stream data thus encoded by the encoding unit 11a is converted into packets by the packeting apparatus 25, and the packets are stored temporarily in the transmission buffer 26, and then sent to the network 10 at regular intervals.

Next, the decoding unit 11b shown in FIG. 2 is described below.

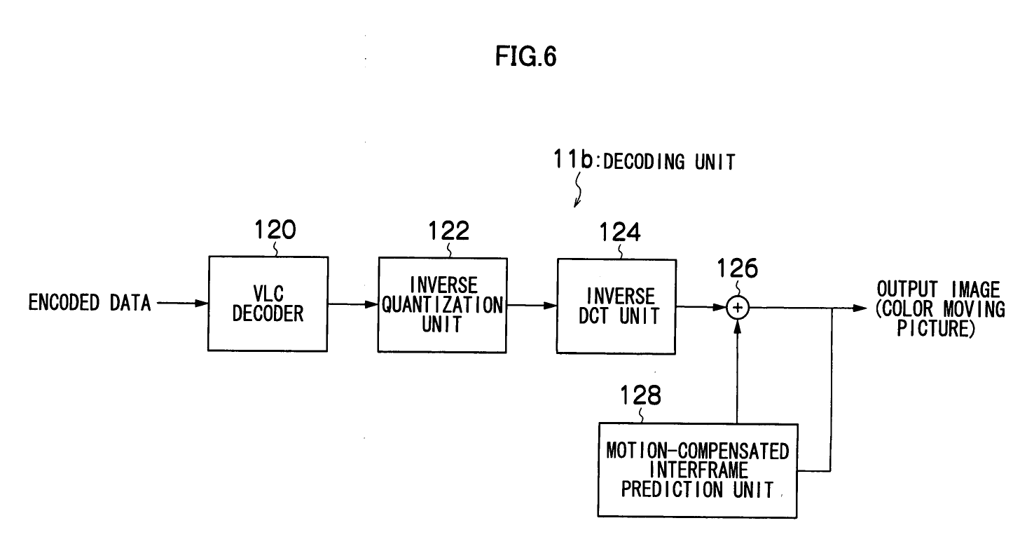

FIG. 6 is a schematic diagram of the decoding unit 11b, and it shows the portions about decoding color moving pictures, in particular.

This decoding unit 11b comprises a VLC decoder 120, an inverse quantization unit 122, an inverse DCT unit 124, an adder 126, and a motion-compensated interframe prediction unit 128.

The decoding unit 11b restores a moving picture by means of an expansion process which is inverse to the compression process carried out by the encoding unit 11a.

The VLC decoder 120 generates quantized DCT coefficients by Huffman decoding of the encoded data inputted from the streaming unit 22, and outputs the DCT coefficients thereby generated to the inverse quantization unit 122. The inverse quantization unit 122 generates DCT coefficients by inverse quantization of the quantized DCT coefficients inputted from the VLC decoder 120, and outputs the DCT coefficients thereby generated to the inverse DCT unit 124.

The inverse DCT unit 124 generates a digital image signal by inverse DCT processing of the input DCT coefficients, and outputs the digital image signal thereby generated to the adder 126. As the other input of the adder 126, the previous image for which the interframe prediction has been performed is supplied from the motion-compensated interframe prediction unit 128. When the I-picture is inputted from the inverse DCT unit 124, then the adder 126 outputs the input image without alteration, whereas when the P-picture or the B-picture is inputted from the inverse DCT unit 124, then the adder 126 adds the predicted image supplied from the motion-compensated interframe prediction unit 128 to the input image, and outputs the sum image.

The video data thus decoded by the decoding unit 11b is converted into an NTSC signal by the video output unit 17 and then outputted to the monitor 5.

Next, a method of varying the volume of the data that is encoded by the encoding unit 11a is described below.

The bandwidth estimation unit 11c shown in FIG. 2 estimates the transfer bandwidth of the communication path between the communication terminals 1a and 1b, and sends transfer bandwidth information representing the estimated transfer bandwidth to the encoding unit 11a.

This transfer bandwidth information is supplied to the color compression unit 106a of the DCT unit 106, as shown in FIG. 4. The color compression unit 106a compresses the data of the four blocks Cr1, Cr2, Cb1 and Cb2 of the color differential signals Cr and Cb, in the macro-block MB comprising 8 blocks shown in FIG. 5C, in accordance with the transfer bandwidth information, and outputs a macro-block MB' including the four blocks of the luminance signal Y and the four blocks of the compressed color differential signals Cr and Cb. The encoding of each of the blocks constituting the macro-block MB' is performed by means of the process as described above.

Next, the method of compressing the color differential signals Cr and Cb in the color compression unit 106a is described below.

The color differential signals Cr and Cb each have 8 bits describing 256 possible shades. If the color compression unit 106a estimates, on the basis of the input transfer bandwidth information, that sufficient bandwidth for transmitting a color moving picture in full is available, then the color compression unit 106a outputs the color differential signals Cr and Cb directly in the form of 8-bit data without compression.

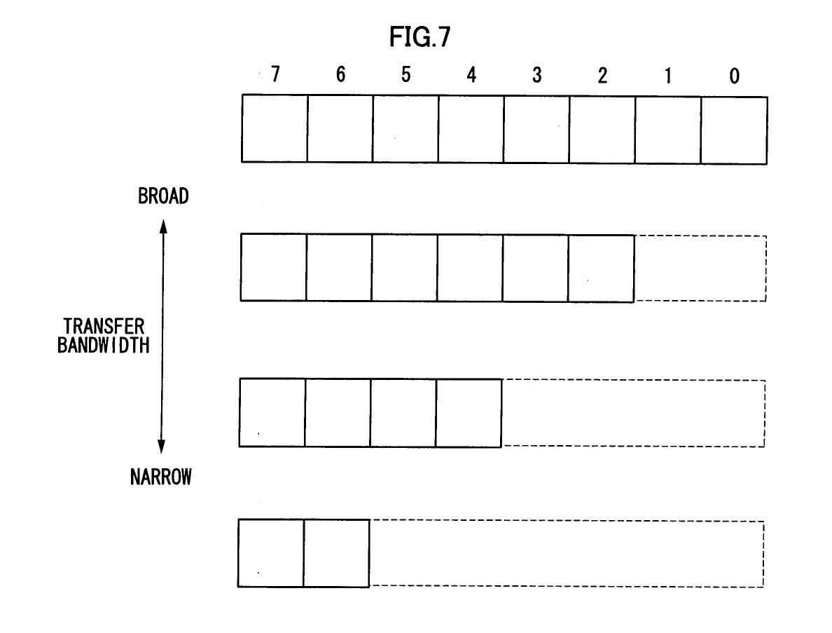

On the other hand, if the color compression unit 106a estimates, on the basis of the input transfer bandwidth information, that sufficient bandwidth for transmitting a color moving picture in full is not available, then the color compression unit 106a reduces the number of bits of the color differential signals Cr and Cb, as the transfer bandwidth becomes narrower, as shown in FIG. 7.

In this case, the number of bits is reduced by removing a bit(s), starting from the low bit of the 8 bits, by means of a bit shift operation. Thereby, as the transfer bandwidth narrows, the image gradually approaches a black-and-white image. In the case of the 4:2:2 format shown in FIG. 5C, if the image completely becomes a black-and-white image (if there are no longer any blocks of the color differential signals Cr and Cb), then the number of blocks constituting the macro-block MB' is reduced to one half of that of the macro-block MB, and the data volume can be reduced to one half.

The encoding unit 11a adds compression information indicating how the color differential signals Cr and Cb have been compressed, to the encoded data. The information relating to the compression of the color information may be shared previously between the communication terminals. The encoding unit 11b on the receiving side decodes the encoded data on the basis of the information about the compression that has been sent (or previously shared).

The moving picture communication system according to the present invention is particularly valuable as a communication system between persons having hearing difficulties. More specifically, persons having hearing difficulties communicate with each other by exchanging sign language and gestures, and in this case, it needs to accurately recognize the person's manual gestures in detail. In the moving picture communication system according to the present invention, the color information is reduced in accordance with the transmission bandwidth, but the frame rate and resolution of the moving picture are not reduced. Therefore, even if detailed manual gestures are performed rapidly, these gestures can be reproduced smoothly and with good resolution.

In the present embodiment, the bandwidth estimation unit estimates the transfer bandwidth of the communication path, on the basis of the jitter, but the invention is not limited to this, and it is also possible to monitor the transferred packets of a color moving picture and to estimate the transfer bandwidth on the basis of the related delay information (time stamp differential), by means of the bandwidth estimation units that are synchronized in terms of time between the communication terminals.

Moreover, in this embodiment, a 4:2:2 format is described as an example of an image format including luminance information and two types of color information, but the invention is not limited to this, and a 4:2:0 (4:1:1) or 4:4:4 (1:1:1) format may also be used.

Further, the color differential signals are described as an example of color information, but the invention is not limited to this. In the color space represented by the luminance, the saturation and the hue, it is possible to reduce the color information including the saturation or the hue, or the color information including both the saturation and the hue.

Furthermore, the method of encoding the color moving picture is not limited to the above embodiment.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A moving picture communication system, comprising communication terminals configured to mutually send and receive a color moving picture including luminance information and color information through a network to which the communication terminals are connected, wherein each of the communication terminals comprises:
a transfer bandwidth information acquisition device which acquires transfer bandwidth information representing a bandwidth of a communication path through which the color moving picture is sent and received;
a color information compression device which compresses the color information of the color moving picture in accordance with the transfer bandwidth information acquired by the transfer bandwidth information acquisition device;
an encoding device which encodes the color moving picture outputted from the color information compression device;
a transmission device which transmits the color moving picture encoded by the encoding device;
a reception device which receives the encoded color moving picture transmitted from another of the communication terminals;
a decoding device which decodes the encoded color moving picture received by the reception device; and
a color moving picture output device which outputs the color moving picture decoded by the decoding device.

2. The moving picture communication system as described in claim 1, wherein:
the color information is saturation information; and
the color information compression device reduces an amount of the saturation information as the bandwidth narrows, in accordance with the acquired transfer bandwidth information.

3. The moving picture communication system as defined in claim 1, wherein the transfer bandwidth information acquisition device acquires the transfer bandwidth information in accordance with delay information of the color moving picture received from the other communication terminal performing two-way communication of the color moving picture.

4. The moving picture communication system as defined in claim 1, wherein:
if the color information is compressed by the color information compression device, the encoding device adds compression information relating to this compression to the encoded color moving picture; and
if the reception device receives the compression information in addition to the color moving picture, the decoding device decodes the received color moving picture in accordance with this compression information.
